(19) United States
(12) Patent Application Publication
(10) Pub. No.: US 2006/0202980 A1
(43) Pub. Date: Sep. 14, 2006

(54) Display chip protection device for a display

(75) Inventor: Kao-Yang Wu, Taoyuan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/370,906

(22) Filed: Mar. 9, 2006

(30) Foreign Application Priority Data
Mar. 11, 2005 (TW) 94107476

(51) Int. Cl. G09G 5/00

(52) U.S. Cl. 345/204

(57) ABSTRACT

A display chip protection device for a display receiving an image signal and a power signal comprises a display chip and a protection unit. The display chip receives the power signal and the image signal from the protection unit. The protection unit is coupled to the display chip for receiving the power signal and the image signal. When receiving the power signal, the protection unit transmits the image signal to the display chip so that the display chip receives the power signal earlier than the image signal.

### BACKGROUND

The invention relates to a display and more particularly to a display with a display chip protection device.

A display chip can be usually damaged by unexpected EOS (Electrical-Over-Stress) due to latch-up caused by the display chip receiving an image signal earlier than a power signal. With a LCD as an example, when the LCD electrically connects to a computer and the display chip of LCD receives the image signal before the power signal, the display chip might be damaged due to a timing control error.

To ameliorate this problem, conventional designs utilize a resistor serially connected to the input terminal of the image signal of the display chip to limit the power transmitted to the display chip, thus reducing, but not eliminating, the probability that the display chip may be damaged. If the controller providing the image signal suddenly receives a power surge caused by strike for example, the display chip may be damaged even if the resistor limits the power transmitted to the display chip.

### SUMMARY

The invention is generally directed to a device for preventing a display chip from receiving an image signal prior to a power signal.

The invention provides a display chip protection device for a display receiving an image signal and a power signal comprising a display chip and a protection unit. The display chip receives the power signal and the image signal from the protection unit. The protection unit is coupled to the display chip for receiving the power signal and the image signal. When receiving the power signal, the protection unit transmits the image signal to the display chip so that the display chip receives the power signal prior to the image signal.

### BRIEF DESCRIPTION OF THE DRAWINGS

FIG. 1 is a block diagram of an embodiment of the invention.

FIG. 2 is a waveform according to FIG. 1.

FIG. 3 is a monitor 30 with protection units 36a-36e according to the invention.

### DETAILED DESCRIPTION

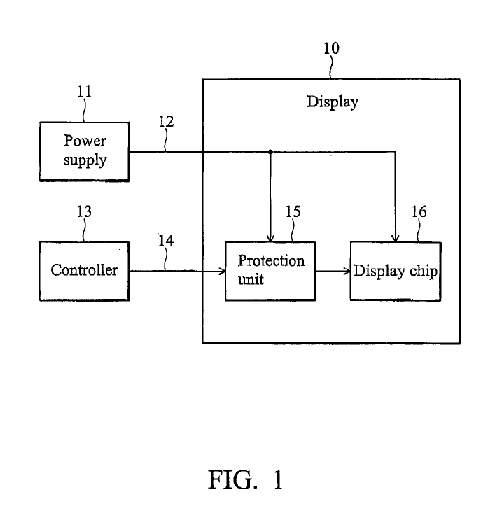

FIG. 1 is a block diagram of an embodiment of the invention. Display 10 receives a power signal 12 provided by a power supply 11 and an image signal 14 provided by a controller 13. A protection unit 15 and a display chip 16 of the display 10 receives the power signal 12 provided by the power supply 11. The protection unit 15 is coupled to the display chip 16 and receives the image signal 14 from controller 13. When receiving the power signal 12, the protection unit 15 transmits the image signal 14 to the display chip 16 to avoid damaging display chip 16.

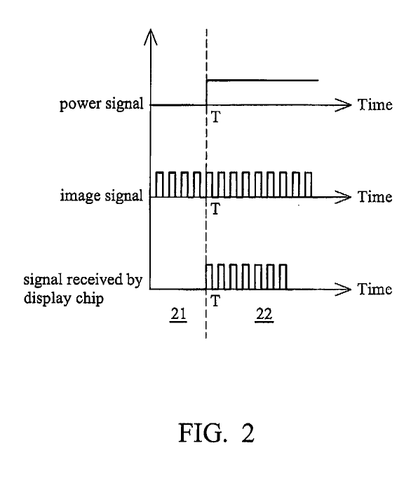

FIG. 2 is a waveform according to FIG. 1. Area 21 and area 22 are divided at time T. Area 21 represents a situation in which the protection unit 15 does not receive a power signal 12 and area 22 represents another situation in which the protection unit receives the power signal 12. In FIG. 2, the waveform of the power signal represents that the power supply 11 provides a power signal 12 at time T, but is not limited to a DC power signal. In area 21, the display chip 16 can not receive the image signal 14 from the protection unit 15 because the protection unit 15 does not receive power signal 12. In area 22, the display chip 16 receives the image signal 14 from the protection unit 15 because the protection unit 15 has been enabled by the power signal 12.

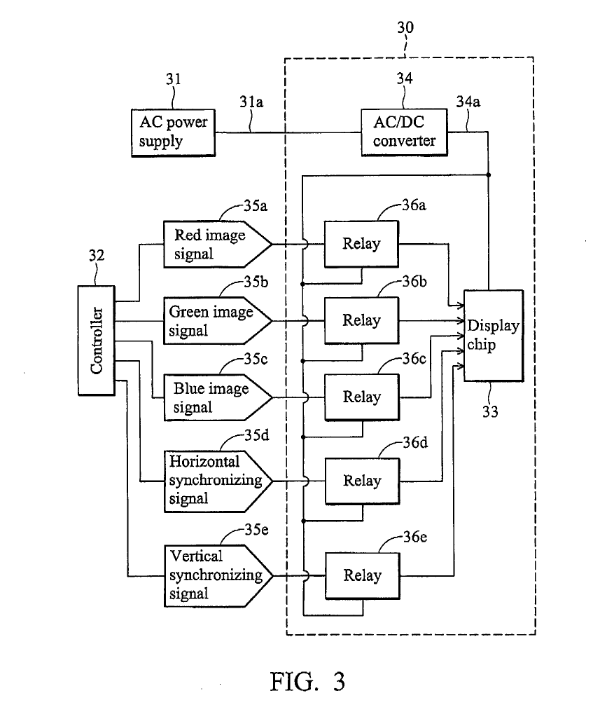

FIG. 3 is a monitor 30 with protection units 36a-36e. Monitor 30 receives power from power supply 31 and image signals from controller 32, wherein the image signals further comprise red image signal 35a, green image signal 35b, blue image signal 35c, horizontal synchronizing signal 35d and vertical synchronizing signal 35e. An AC/DC converter 34 built in the monitor 30 transforms the AC power signal 31a from power supply 31 into a DC power signal 34a. A relay 36a coupled to display chip 33 receives DC power signal 34a and red image signal 35a. When the relay 36a receives the DC power signal 34a, the relay 36a transmits the red image signal 35a to the display chip 33. Conversely, the relay 36a does not transmit the red image signal 35a to the display chip 33. A relay 36b coupled to display chip 33 receives DC power signal 34a and green image signal 35b. When the relay 36b receives the DC power signal 34a, the relay 36b transmits the green image signal 35b to the display chip 33. Conversely, the relay 36b does not transmit the green image signal 35b to the display chip 33. A relay 36c coupled to display chip 33 receives DC power signal 34a and blue image signal 35c. When the relay 36c receives the DC power signal 34a, the relay 36c transmits the blue image signal 35c to the display chip 33. Conversely, the relay 36c does not transmit the green image signal 35c to the display chip 33. A relay 36d coupled to display chip 33 receives DC power signal 34a and horizontal synchronizing signal 35d. When the relay 36d receives the DC power signal 34a, the relay 36d transmits the horizontal synchronizing signal 35d to the display chip 33. Conversely, the relay 36d does not transmit the horizontal synchronizing signal 35d to the display chip 33. A relay 36e coupled to display chip 33 receives DC power signal 34a and vertical synchronizing signal 35e. When the relay 36e receives the DC power signal 34a, the relay 36e transmits the vertical synchronizing signal 35e to the display chip 33. Conversely, the relay 36e does not transmit the vertical synchronizing signal 35e to the display chip 33.

While the invention has been described by way of example and in terms of preferred embodiment, it is to be understood that the invention is not limited thereto. To the contrary, it is intended to cover various modifications and (as would be apparent to those skilled in the art) . Therefore, the scope of the appended claims should be accorded the broadest interpretation so as to encompass all such modifications.

What is claimed is:

1. A display chip protection device for a display receiving an image signal and a power signal comprising:
a display chip for receiving the power signal; and
a protection unit coupled to the display chip for receiving the power signal and the image signal; when receiving the power signal, the protection unit transmits the image signal to the display chip.

2. The device of claim 1, wherein the power signal is an AC power signal.

3. The device of claim 1, wherein the power signal is a DC power signal.

4. The device of claim 1, wherein the display chip receives the power signal prior to the image signal by the protection unit.

5. The device of claim 4, wherein the protection unit is a relay; when receiving the power signal, the relay turns on and transmits the image signal to the display chip.

6. A method for protecting a display chip by a protection unit, comprising:
receiving a power signal and an image signal by the protection unit;
when the protection receives the power signal, the protection unit allows the image signal entering the display chip; and
when the protection unit does not receive the power signal, the protection unit stops the image signal entering the display chip.

7. The method of claim 6, wherein the protection unit is a switch device.

8. The method of claim 6, wherein the protection unit is a relay device.
